(19) United States
(12) Patent Application Publication
(10) Pub. No.: US 2004/0213172 A1
(43) Pub. Date: Oct. 28, 2004

(54) Anti-spoofing system and method

(76) Inventors: Robert L. Myers, Mississauga (CA); Paulo Neves Francisco, Mississauga (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/421,716

(22) Filed: Apr. 24, 2003

(51) Int. Cl. H04Q 7/00

(52) U.S. Cl. 370/313; 709/229

(57) ABSTRACT

A method for preventing network address spoofing within a wireless local area network (LAN) that includes an access controller and first and second radio units. The method first associates a first mobile unit to the first radio unit, determines the network address of the first mobile unit and maintains a connectivity record that contains the network address and identifies that the first radio unit has been associated with. If a second mobile unit requests association with the second radio unit then the network address of the second mobile unit is determined. If the network address of the second mobile unit is the same as the network address of the first mobile unit then the connectivity record associated with the network address of said first and second mobile units is checked. If the connectivity record indicates an association with the first radio unit then an anti-spoofing protocol is executed.

### FIELD OF THE INVENTION

This invention relates to a wireless communication network and more particularly to a wireless communication system and method for preventing network address spoofing.

### BACKGROUND OF THE INVENTION

An attacker wishing to disrupt a wireless local area network (LAN) has a wide arsenal available to them. Many of these tools rely on using a faked MAC or IP address, masquerading as an authorized wireless access point or as an authorized client. Using this technique, conventionally termed “spoofing”, an attacker can launch denial of service attacks, bypass access control mechanisms, or falsely advertise services to wireless clients. “Spoofing” is difficult to detect because the attacker can present himself as an authorized client by using an altered MAC address. As nearly all wireless network interface cards (NICs) permit changing their MAC or IP addresses to an arbitrary value using vendor-supplied drivers, open-source drivers or various application programming frameworks, it is trivial for an attacker to wreak havoc on a target wireless LAN.

Specifically, MAC addresses have long been used as the singularly unique layer 2 network identifier in LANs. Through controlled, organizationally unique identifiers (OUI) allocated to hardware manufacturers. MAC addresses are globally unique for all LAN-based devices in use today. In many cases, the MAC address is used to grant varying levels of network or system privileges to a user. This method of client tracking is also used within 802.11 wireless networks. Attackers targeting wireless LANs utilize the ability to change their MAC address to circumvent network security measures. More sophisticated attackers change the MAC address of their device to one that is otherwise authorized to bypass access control lists or to escalate network privileges.

As is conventionally known, IP is the connectionless, unreliable network protocol in the TCP/IP suite. It has two 32-bit header fields to hold address information. IP's job is to route packets around the network. It provides no mechanism for reliability or accountability, for that, it relies on the upper layers. IP simply sends out datagrams and hopes they make it intact. If they don't, IP can try to send an ICMP error message back to the source, however this packet can get lost as well. (ICMP is Internet Control Message Protocol and it is used to relay network conditions and different errors to IP and the other layers.) IP has no means to guarantee delivery. Since IP is connectionless, it does not maintain any connection state information. Each IP datagram is sent out without regard to the last one or the next one. This, along with the fact that it is trivial to modify the IP stack to allow an arbitrarily chosen IP address in the source (and destination) fields make IP easily subvertable. In IP address spoofing, an attacker sends data from an arbitrary source address and does not expect to see a response to their actual source IP address.

In contrast, MAC address spoofing consists of altering the MAC address of a device and “impersonating” as another previously authorized device. That is, when an attacker changes their MAC address they continue to utilize the wireless card for its intended layer 2 transport purpose, transmitting and receiving from the same source MAC. The issue of MAC address spoofing in a wireless LAN network is most prevalent when there is either no authentication for the user or the authentication method happens through a facility called a “Captive Portal”. Captive Portals are essentially firewalls that sit in the network between the user and where their desired services reside. The Captive Portal denies all access to the network until the user goes through an authentication process based on web technology. In order to circumvent the firewall the user must first launch their Internet Browser and perform an authentication procedure on a web server. The most common implementations of Captive Portals reside on a device that sits in the network between a group of access points and the desired destination network. As packets arrive at the interface of the captive portal if checks the MAC or IP address to determine if they have been authenticated or not. The Captive Portal has no idea if that packet actually came from a legitimate user or not, just that the MAC or IP address is valid and allowed to send and receive packets from the desired network.

### SUMMARY OF THE INVENTION

The invention provides in one aspect, a method for preventing network address spoofing in respect of a plurality of mobile units within a wireless network, said wireless network including an access controller and first and second radio units, said method comprising:

(a) associating a first mobile unit to the first radio unit, determining the network address of said first mobile unit and maintaining a connectivity record that contains said network address and that indicates an association with said first radio unit;

(b) receiving an associate request from a second mobile unit to associate with the second radio unit and determining the network address of said second mobile unit;

(c) determining if the network address of the second mobile unit is the same as the network address of the first mobile unit;

(d) if the determination in (c) is true then retrieving the connectivity record associated with the network address of said first and mobile units and determining whether said connectivity record indicates an association with the first radio unit;

(e) if the determination in (d) is true then executing an anti-spoofing protocol.

In another aspect the invention provides a wireless network for preventing network address spoofing of a first mobile unit by a second mobile unit, said network comprising:

(a) first and second radio units;

(b) an access controller coupled to said first and second radio units and being adapted to:

(i) associate the first mobile unit to the first radio unit, determine the network address of said first mobile unit and maintain a connectivity record that contains said network address and that indicates an association with said first radio unit;

(ii) receive an associate request from a second mobile unit to associate with the second radio unit and determine the network address of said second mobile unit;

(iii) determine if the network address of the second mobile unit is the same as the network address of the first mobile unit;

(iv) retrieve the connectivity record associated with the network address of said first and mobile units if the determination in (iii) is true and determine whether said connectivity record indicates an association with the first radio unit; and

(v) execute an anti-spoofing protocol if the determination if (iv) is true.

Further aspects and advantages of the invention will appear from the following description taken together with the accompanying drawings.

### BRIEF DESCRIPTION OF THE DRAWINGS

In the accompanying drawings:

FIG. 1 is a block diagram of an example of a high level implementation of the wireless local area network (LAN) of the present invention;

FIG. 2A is a block diagram illustrating the hardware components of the radio unit of FIG. 1;

FIG. 2B is a block diagram illustrating the software components of the radio unit of FIG. 1;

FIG. 3A is a block diagram illustrating the hardware components of the access controller of FIG. 1;

FIG. 3B is a block diagram illustrating the software components of the access controller of FIG. 1;

FIG. 4A is a schematic drawing illustration of the radio unit header used for communication between the radio unit and access controller of FIG. 1;

FIG. 4B is a schematic drawing illustration of the mobile unit data header used for encapsulated communication between the radio unit and access controller of FIG. 1;

FIG. 4C is a schematic drawing illustrating the complete WASSP communication data packet utilized by the wireless LAN of FIG. 1;

FIG. 5A is a schematic of the mobile unit end-to-end protocol stack associated with the mobile unit, radio unit and access controller of FIG. 1;

FIG. 5B is a schematic of the protocol stack associated with the radio unit and the access controller of FIG. 1;

FIG. 6 is a block diagram of a wireless network that illustrates the spoofing phenomenon where more than one mobile unit uses the same MAC or IP address within the wireless local area network (LAN) of FIG. 1;

FIG. 7 is a schematic message flow diagram illustrating how the mobile unit session table is built when a first mobile unit connects to a first radio unit and then to a second radio unit of FIG. 6;

FIG. 8 is a schematic message flow diagram illustrating a spoofing attempt by a second mobile unit of FIG. 6;

FIG. 9A is a schematic diagram illustrating the radio unit session table record;

FIG. 9B is a schematic diagram illustrating the message exchange between the radio unit and the access controller of FIG. 6 during the radio unit authentication process;

FIG. 10A is a schematic diagram illustrating the mobile unit session table record;

FIG. 10B is a schematic diagram illustrating the message exchange between the mobile unit, the radio unit and the access controller of FIG. 6 during the mobile unit connection process;

FIG. 11 is a block diagram illustrating data processing within the control and data plane of the wireless local area network (LAN) of FIG. 6;

FIG. 12 is a flowchart illustrating the session matching process steps that are executed by the source check module of FIG. 11; and

FIG. 13 is a flowchart illustrating the message processing steps that are executed by the IP forward module of FIG. 11.

### DETAILED DESCRIPTION OF THE INVENTION

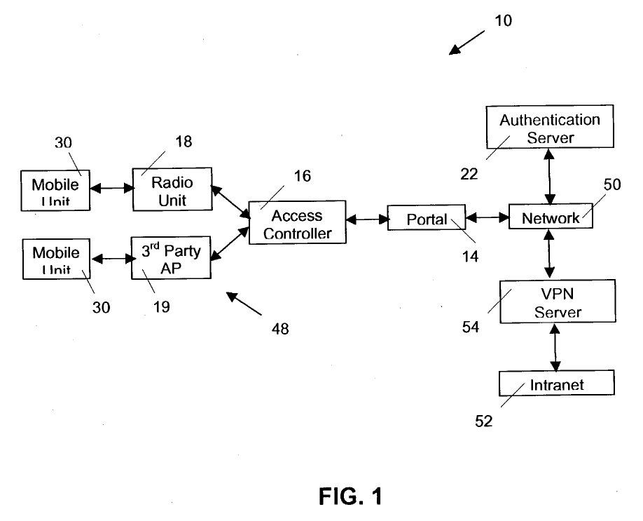

FIG. 1 illustrates the main components of a wireless network 10 operating in accordance with a preferred embodiment of the invention. Wireless network 10 includes, a plurality of access controllers 16, a plurality of radio units 18 and third party access points 19, mobile units 30, and a back-end network (e.g. intranet) 50. Using the communication protocol of the present invention, wireless network 10 provides mobile unit traffic segmentation for a plurality of mobile units 30 for the purpose of assigning virtual networking services (VNS).

Mobile unit 30 is any electronic device that will support wireless communication with the radio unit 18 such as the IEEE 802.11 standard, Bluetooth standard or any other wireless protocol for wireless communication. Mobile unit 30 could be a laptop, personal digital assistant (PDA) or other device capable of wireless communication.

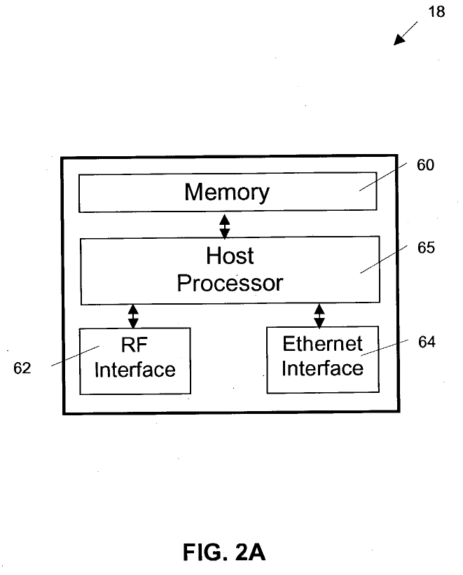

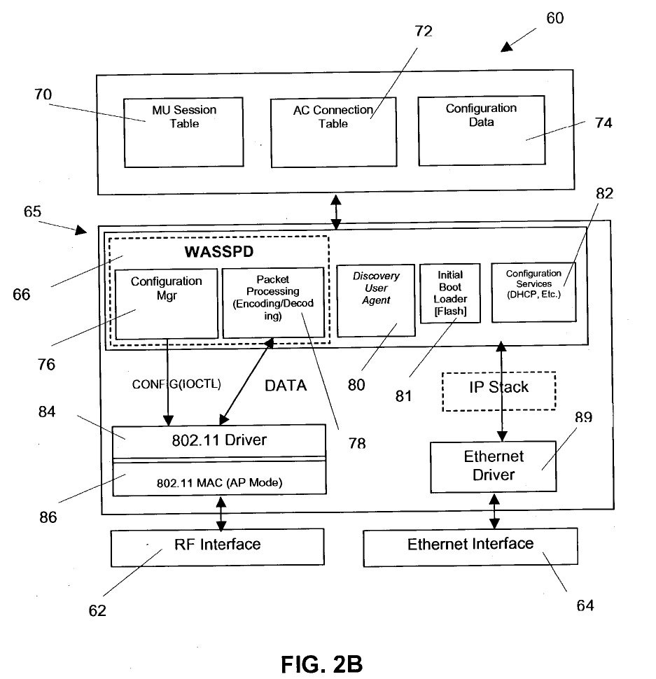

Radio unit 18 acts as the connection point for the mobile unit 30 to the wireless network 10. As shown in FIG. 2A, radio unit 18 includes an RF interface 62 (i.e. receiver) capable of receiving RF signals from mobile unit 30. RF receiver 62 is capable of receiving signals from the mobile unit 30 in accordance with a wireless standard such as the IEEE 802.11 standard, Bluetooth standard or other wireless communication standard. Radio unit 18 also includes a memory 60, a host processor 65 as well as an Ethernet interface 64. Several radio units 18 can be connected through a backbone, which can be any suitable network technology, such as an Ethernet LAN. It should be understood that wireless network 10 is also able to accommodate third party access points 19 through which to receive mobile unit 30 communication data using other appropriate protocols that are dependant on the specific parameters suited to the particular software and hardware configuration of third party access points 19.

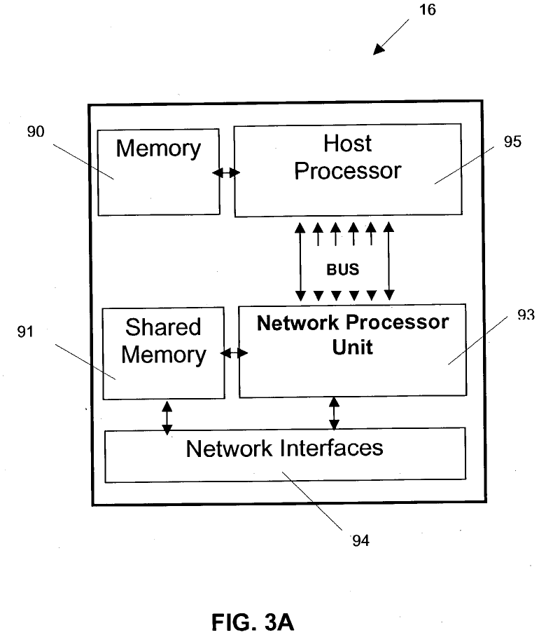

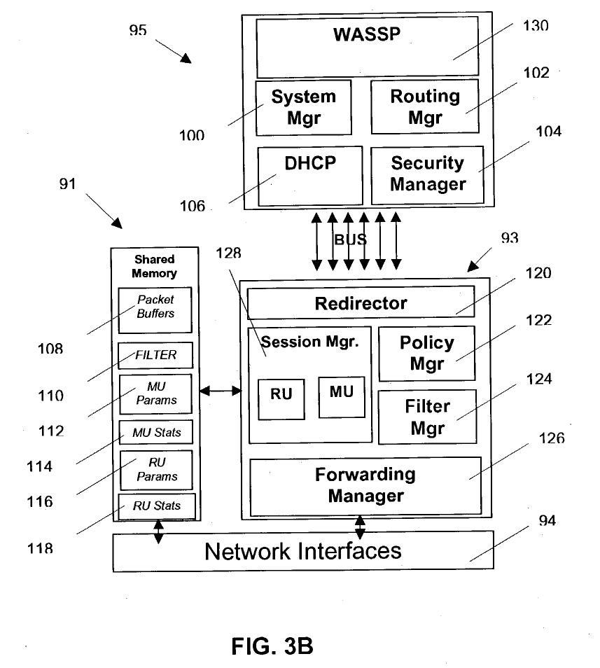

Access controller 16 is connected within wireless network 10 through a network connection such as Ethernet. Access controller 16 is in communication with the radio unit 18 by way of portal 14. As shown in FIG. 3A, access controller 16 includes a memory 90, host processor 95, shared memory 91, a plurality of network process units 93 and a plurality of network interfaces 94. Shared memory 91 is a memory disk or other data storage device (e.g. RAM) that stores mobile unit session data and radio unit session data as will be described.

Each radio unit 18 is associated with a radio unit session, and this radio unit session is stored as radio unit session data in shared memory 91. However, it should be understood that for availability purposes, the radio unit session could be stored using a RU_REGISTRY service that keeps session info in OS memory 90 on the Host Processor 95. Also, each mobile unit 30 is associated with a mobile unit session, and this mobile unit session is stored as mobile unit session data in shared memory 91. Host processor 95 is used to provide local processing of mobile unit session data and radio unit session data as will be described. Network interfaces 94 are used to provide communication functionality between access controller 16 and radio unit 18 and access controller 16 and back-end network 50. It should be understood that strong control and data path linkages are provided between access controller 16 and radio unit 18.

Conventional networks can include portals 14 which provide for communication between radio units 18, back-end network 50 and access controller 16. Portal 14 is implemented by a commercially available router such as a Cisco 3725 Multiservice Access Router (manufactured by Cisco Systems of California). It should be understood that while it is not necessary for proper operation of the invention that portal 14 be present within wireless network 10, however, the present invention is adapted to support any existing portals 14 within wireless network 10.

Back-end network 50 can be either a hard-wired network, such as Ethernet or another configuration supported by the IEEE 802 LAN standards or a wireless network. Back-end network 50 connects to authentication server 22 and to access controller 16 either directly or through communication with portal 14. Authentication server 22 may be any of a number of standard authentication servers depending on the type of protocol adopted for use between access controller 16 and authentication server 22. For example, if the Remote Authentication Dial In User Service (RADIUS) protocol is adopted for use within wireless network 10, then a Steel Belted RADIUS server (manufactured by Funk Software) could be used. As another example, the LDAP protocol could be used with an associated LDAP compatible server. Authentication server 22 is used as part of the IEEE 802.1×standard to authenticate mobile unit 30 as it attempts to connect to the wireless network 10. Authentication server 22 can also be used to authenticate a mobile unit 30 as part of a captive portal feature by capturing the mobile unit 30 information and then sending a message to the authentication server to get confirmation.

Wireless network 10 can also include a VPN router 54 to provide communication between mobile unit 30 and a customer's Intranet 52 over back-end network 50 as shown. Specifically, VPN router 54 provides a secure connection between access controller 16 and a device on the Intranet 52 by providing a logical connection (i.e. a tunnel over a public network).

Each access controller 16 is adapted to receive communication data from each radio unit 18 during connection of mobile unit 30. Based on the communication data transmitted to radio unit 18 during connection of the mobile unit 30, access controller 16 is able to discover VNS factors for the mobile unit communication session and to establish a communication session such that the mobile unit is connected to the network on the basis of the characteristics defined by virtual networking services (VNS). The communication protocol of the present invention encapsulates all packets destined or sent from each mobile unit 30, provides control messages to support management of the mobile unit 30 connection, and provides management messages to support the discovery, configuration and management of a radio unit 18.

FIGS. 2A and 2B illustrate the basic hardware and software components of radio unit 18. As discussed above, radio unit 18 communicates with access controller 16 and passes control information and user data. Radio unit 18 includes a memory 60, a host processor 65, an RF interface 62, and an Ethernet interface 64. Radio unit 18 is designed to be a relatively simple and low cost device that provides RF functionality and generally the same functionality as is currently available in commercially available access points. Radio unit 18 also includes various other standard access point power components including a DC-DC converter and isolation components (not shown). It should be understood that the present communication method of the invention could be implemented using any other type of radio unit 18 (i.e. with a particular hardware architecture).

Memory 60 contains mobile unit session table 70, access controller connection table 72, and configuration data table 74. Host processor 65 and memory 60 are used to implement the software functionality of radio unit 18 as illustrated in FIG. 2B. Host processor 65 provides the execution space for the configuration and control aspects for the operation of radio unit 18.

Specifically, host processor 65 includes a configuration manager 76, a packet processing module 78, a discovery user agent 80, an initial boot loader 81, a configuration services module 82, a 802.11 driver 84, a 802.11 MAC driver 86 and an Ethernet driver 89. The initial boot loader 81 provides the original software image that brings radio unit 18 into an operating mode by providing the storage for the running operating system. Initial boot loader 81 process initializes and enables the wired side of radio unit's 18 communications, which translates into the initialization of the Ethernet interface 64 and the corresponding Ethernet driver 89. Ethernet interface 64 is a conventional Ethernet interface (i.e. 10/100 Ethernet with P.O.E.) and allows radio unit 18 to be connected to existing networks with wired Ethernet.

Following boot initialization, if radio unit 18 is not statically configured with IP address parameters, radio unit 18 utilizes the functionality of the configuration services module 82 to negotiate it's network representation address (IP address), supported through its IP stack, with an applicable external network host via standard methods such as DHCP. Upon properly configuring its network access parameters (IP address) radio unit 18 then uses the functionally of the discovery user agent module 80 and the Service Location Protocol (SLP) to discover an appropriate area service access controller 16. Once radio unit 18 is informed of which access controller 16 it is to connect to for service provision, radio unit 18 engages in an active negotiation of authentication parameters with the access controller 16 to establish a registered session.

The registration process validates the authentication of radio unit 18 and this process is actively tracked in the active AC connection table 72 registry. Once radio unit 18 properly registers with access controller 18, radio unit 18 then engages in the validation and exchange of configuration parameters interpreted and applied by configuration manager 76 that will govern the operation of radio unit 18 and it's network representation assignments (SSID). This negotiation may indicate to radio unit 18 that a software image upgrade may be necessary in order to actively be able to provide network services to mobile units 30 within the definitions of the access controller 16 operations.

The configuration procedure primarily affects the provision of RF services. The configuration procedure is also used to specify operational parameters associated with the wireless protocol driver's and hardware module operations. Once radio unit 18 finishes this configuration process, radio unit 18 then enables RF interface 62 for operation under the specified configuration, which in turn is able to provide network services to a requesting mobile unit 16. RF interface 62 supports different RF technologies (e.g. 802.11b, 802.11a, etc.) Radio unit 18 also includes internal and optional external antennas (not shown) that are coupled to RF interface 62 as conventionally known.

The message exchanges that support registration, configuration and data transport is performed using the WASSP protocol which is implemented by WASSPd module 66. As mobile units 30 associate with radio unit 18 via the RF interface 62, radio unit 18 actively communicates with access controller 16 utilizing the WASSP protocol which is provided by WASSPd module 66 service to provide the registration of mobile unit sessions (which are stored in mobile session table 70) and to exchange any data received or to be delivered to the mobile unit 30.

FIGS. 3A and 3B illustrate the hardware and software components of access controller 16. As discussed above, access controller 16 is where the higher layer packet processing and system management functions reside such as connection management, access security, policy enforcement, management and IP services (filtering, routing QOS, mobility, etc.) The software architecture described in FIG. 3B is implemented through the hardware implementation described in FIG. 3A. Again, it should be understood that the communication method of the present invention could be implemented using any type of commercially available hardware and software including various types of protocol specific drivers.

Access controller 16 includes memory module 90 associated with a host processor 95, a shared memory module 91, a plurality of network process units 93, and a network interface module 94. Host processor 95 and associated memory module 90 is preferably implemented using a Pentium IV-based host, although it should be understood that any commercially available processing host with sufficient memory and processing speed could be used.

FIG. 3B illustrates the specific software modules and their interrelationship within access server 16. The software of access controller 16 is adapted to support the high level features of radio unit management (e.g. auto configuration, software loading, failover, statistics), mobile unit services (e.g. connection management, address assignment) and access security (e.g. RADIUS security, captive portal features, 802.11 i), policy features (e.g. packet filtering, QOS), mobility (inter and intra access controller), VNS (i.e. traffic steering, VLAN), and system management (i.e. SNMP, bootp, HTML, accounting and statistics) as will be further discussed.

Host processor 95 includes a WASSP service module 130, a system manager 100, a routing manager 102, a security manager 104, and a DHCP module 106 to keep track of IP addresses. Host processor 95 constitutes a management plane that provides high level management functionality (i.e. management plane) to access controller 16 and is capable of interfacing with a Web server and other back end interfaces.

Shared memory module 91 includes data for routing and filtering data packets as well as for radio unit 18 and mobile unit 30 sessions. Specifically, shared memory module 91 includes packet buffers 108, filter 110, mobile unit parameter table 112, mobile user statistics table 114, radio unit parameter table 116, and a radio unit statistics table 118.

Network processor unit 93 includes redirection module 120, policy manager 122, filter manager 124, forwarding manager 126, session manager 128. Network process unit 93 is functionally divisible into a control plane and a data plane which share access to shared memory module 91. The control plane of network process unit 93 communicates with host processor 95 via a PCI bus or via an Ethernet link.

Data received at network interface module 94 is read into the packet buffer table 108 and is processed according to the rules mandated by the information in the session tables associated with shared memory 91. These session tables provide the definition for registered devices in the mobile and radio unit parameter tables 112 and 116. These definitions dictate the policy to be applied to registered devices, such as the filter definitions stored in filter definition table 110 that apply to such packets. Most of the packets received at the network interface module 94 represent mobile unit 30 packets that can derive enough treatment information from the session tables stored in the stored memory 91 and be processed entirely within the network interface 94 realm. However, packets not directly related to the data flow of a registered mobile unit 30 are delivered for further processing to network processor unit 92.

Specifically, WASSP packets relevant to the control and management of registered devices are handled by WASSPd service module 130, which processes the packets and interacts with the necessary application within session management module 128, which in turn may interact with additional 124 or even with system manager 100 for configuration related activities. Additionally, packets originating from mobile unit 30 or from other network hosts connected to access controller 16 may be delivered to host processor 95 for processing if they pertain to network management and representation services (e.g. address requests handled by DHCP server 106 or routing updates handled by routing manager 102). Mobile unit 30 packets that relates to user authentication may be processed by the redirector modue 120 in cooperation with the security manager 104 which is responsible for the propagation of user authentication status change notifications.

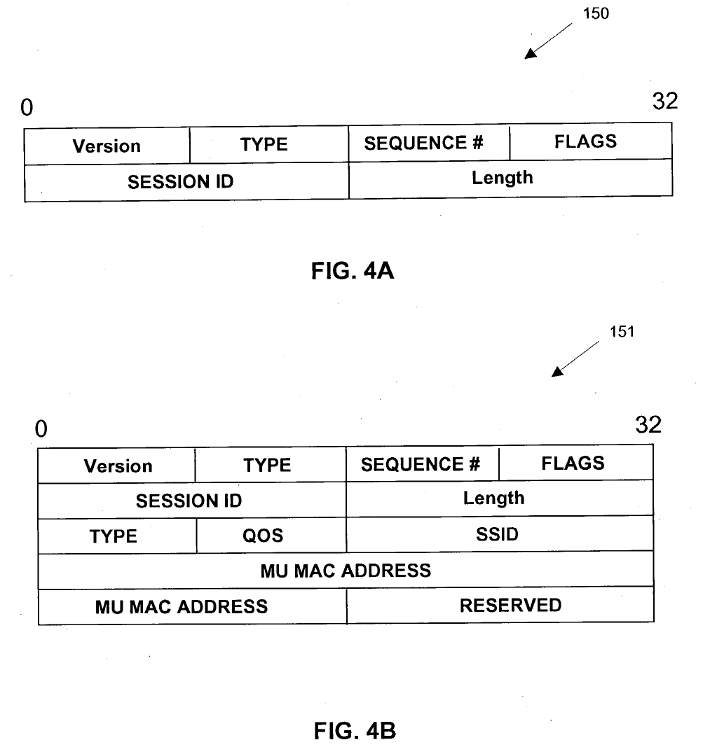

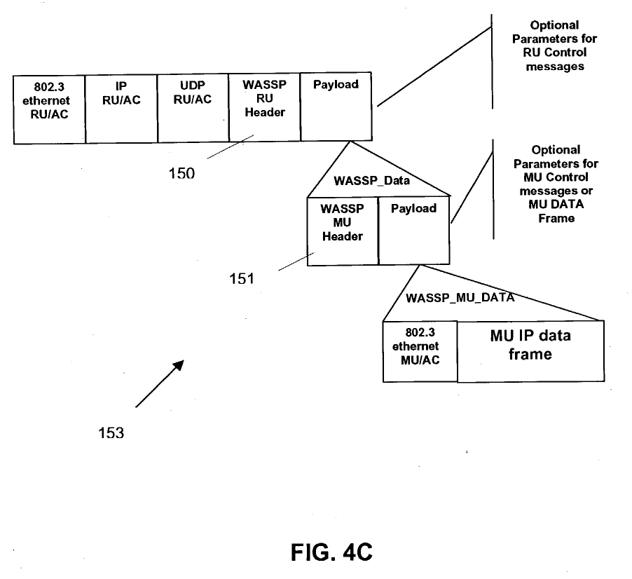

Referring now to FIGS. 1, 4A, 4B and 4C, as discussed above, the present invention achieves effective segmentation of mobile units 30 by providing strong control and data path linkages between access controller 16 and radio units 18. This allows various emerging wireless LAN services (e.g. security with 802.11i, QoS with 802.11e, etc.) to be applied to end-to-end mobile device communications.

Specifically, radio unit 18 and access controller 16 are in communication with each other within wireless network 10 at layer 3. This is achieved by encapsulating the necessary data in an IP (Internet protocol) packet with an IP header. This allows access controller 16 to be in a different physical location from radio unit 18, while still allowing communication between access controller 16 and radio unit 18. Through this encapsulation, data and control information can be exchanged between radio unit 18 and access controller 16. These IP packets with their IP headers are transferred on the network using UDP/IP, although it should be understood that any suitable protocol such as TCP/IP (or even an independent protocol on top of IP) could be used.

FIGS. 4A and 4B illustrate the headers added to the data to form an IP packet used in communicating between radio unit 18 and access controller 16 and FIG. 4C illustrates how these headers are incorporated into the general WASSP data packet. The data in the IP packet is treated as two separate layers, namely a radio unit layer having a RADIO UNIT HEADER 150, and mobile unit layer having a MOBILE UNIT HEADER 151. Once the IP packet reaches access controller 16, the headers 150 and 151 are removed and radio unit layer and mobile unit layer messages are interpreted by access controller 16.

FIG. 4A illustrates RADIO UNIT HEADER 150. The radio unit layer is used to establish a communication session between radio unit 30 and access controller 16. Once this session is established, this layer is then utilized as the transport for the mobile unit layer. RADIO UNIT HEADER 150 includes the header fields: Version, TYPE, SEQUENCE#, FLAGS, SESSION ID and LENGTH. The header field Version specifies the protocol version. The radio unit header field TYPE (note there is a mobile unit TYPE field which will be discussed later) identifies the type of radio unit message that is contained in the packet. The header field SEQUENCE# is used to determine the order for multi-packet transmissions that occur when an original packet is fragmented into several packets. The header field FLAGS provides notification of message flow related information (e.g. an indication that a particular message represents the last message in a sequenced set). For example, these fields are used in the situation where a packet is received from mobile unit 30 or from a host that sends a packet that is at the maximum packet size for Ethernet. Since the packet then needs to be encapsulated into the WASSP packet and more data needs to be added to it, the maximum packet size supported by Ethernet would be exceeded. Accordingly, it is necessary to split the packet apart into fragments that will fit into the Ethernet packet. The header field SESSION ID (16) identifies the radio unit session to associate the message with. The header field LENGTH specifies the length of the payload.

FIG. 4B illustrates the MOBILE UNIT HEADER 151. It should be noted that the first few fields of MOBILE UNIT HEADER 151 constitute the RADIO UNIT HEADER 150 discussed above. MOBILE UNIT HEADER 151 provides the means for mobile unit 30 to validate with access controller 16 and for the exchange of data between mobile unit 30 and access controller 16. Once this data is encapsulated at radio unit 18, the data is sent to access controller 16. As shown in FIG. 4C, MOBILE UNIT HEADER 151 is carried within the Payload segment associated with RADIO UNIT HEADER 150. The Version, SEQUENCE#, FLAGS, SESSION ID and LENGTH are part of the RADIO UNIT HEADER 150 that encapsulates the MOBILE UNIT HEADER 151.

MOBILE UNIT HEADER 151 also including the following mobile unit related header fields: TYPE, QOS, SSID, MU MAC ADDRESS and RESERVED. The first header field TYPE (mobile unit TYPE field) indicates the subtypes of MOBILE UNIT_DATA which indicates that this message is applicable to a particular mobile unit operation within radio unit 18. Put another way, the TYPE field indicates the purpose of the message as applicable to mobile operation, and may refer to control operations or simply to carry mobile unit 30 data. The QOS field is the QoS identifier.

The header field SSID contains the SSID that mobile unit 30 is using to access radio unit 18. It is being contemplated to change the designation SSID to VNS_ID in order to separate the SSID assignments from the corresponding policy provided by an SSID. Since mobile units 30 are mapped to a VNS, this field should be understood to represent their current association state to the representing VNS. The header field MU MAC address field contains the MAC address of mobile unit 30 accessing wireless network 10 through radio unit 18 or MU MAC ADDRESS. The header field RESERVED is reserved for future use.

As shown in FIGS. 4A and 4B, both RADIO UNIT HEADER 150 and MOBILE UNIT HEADER 151 allow for two types of messages, namely, radio unit layer messages and mobile unit layer messages. The messages used by the radio unit layer are specified in the header field TYPE field of the radio unit header 150 and include an authentication request message, an authentication confirmation message, a session data message, a set state message, a poll message, a halt message and a re-activate message.

Service Location Protocol (SLP) is used by radio unit 18 to discover the location of access controller 16. Access controller 16 uses the SLP message to offer its services to radio unit 18. The authentication request message is used by radio unit 18 to request registration of a radio unit session with access controller 16. The authentication confirm message is used by access controller 16 to confirm the registration of the registration of a radio unit session for radio unit 18 in storage module 60 of access controller 16. The session data message is used as the transport of mobile unit layer messages. When session data message is indicated in header field TYPE field of radio unit header 110, the message body is not interpreted by radio unit layer. The set state message allows access controller 16 to alter the operation state of radio unit 18. The poll message, allows access controller 16 to poll access controller 16 to re-activate radio unit 18. The re-activate message is used by access controller 16 to re-activate radio unit 18 when it has been halted. The halt message allows access controller 16 to halt operation of radio unit 18.

The messages used by the mobile unit layer are specified in the header field TYPE field of the MOBILE UNIT HEADER 151 and are a subtype of radio units 18 WASSP_DATA message TYPE and carried as payload for WASSP_DATA as discussed above. In order for these mobile unit messages to be used, the MOBILE UNIT HEADER field TYPE (see FIG. 4B) must indicate a session data message. These messages include an associate request (Associate_Req), an associate response (Associate_Rsp), a re-association request (Re-association_Req), a re-association response (Re-association_Rsp), and most importantly a data transport (mu_data) message indicator. The mu_data is utilized as the transport for mobile unit 30 related data exchanges. In particular, during the user authentication phase of session establishment, these messages encapsulate the applicable message sets for user authentication that are comprised of an EAP (Extensible Authentication Protocol) request (EAP_Req), an EAP (Extensible Authentication Protocol) response (EAP_Rsp), a user authentication (User Authentication_Req), a user validation (User_Validation_Rsp). Following authentication, the mu_data encapsulation then carries the user's data frames which provide network representation parameters such as a Dynamic Host Configuration Protocol (DHCP) request (DHCP_Req), and DHCP response (DHCP_Rsp); or general purpose data messages such as HTML requests (HTML_Req).

FIG. 4C is a schematic diagram that shows the complete WASSP data packet. It contains an 802.3 Ethernet RU/AC segment, an IP RU/AC segment, an UDP RU/AC segment, RADIO UNIT HEADER 150, and a RU Payload segment. The RU Payload segment contains operational parameters for RU control messages and specifically contains WASSP_Data comprising MOBILE UNIT HEADER 151 and a MU Payload segment. The MU Payload segment contains optional parameters for MU control messages or MU Data frame and specifically, WASSP_MU_DATA which comprises an 802.3 Ethernet MU/AC segment and a MU IP data frame segment.

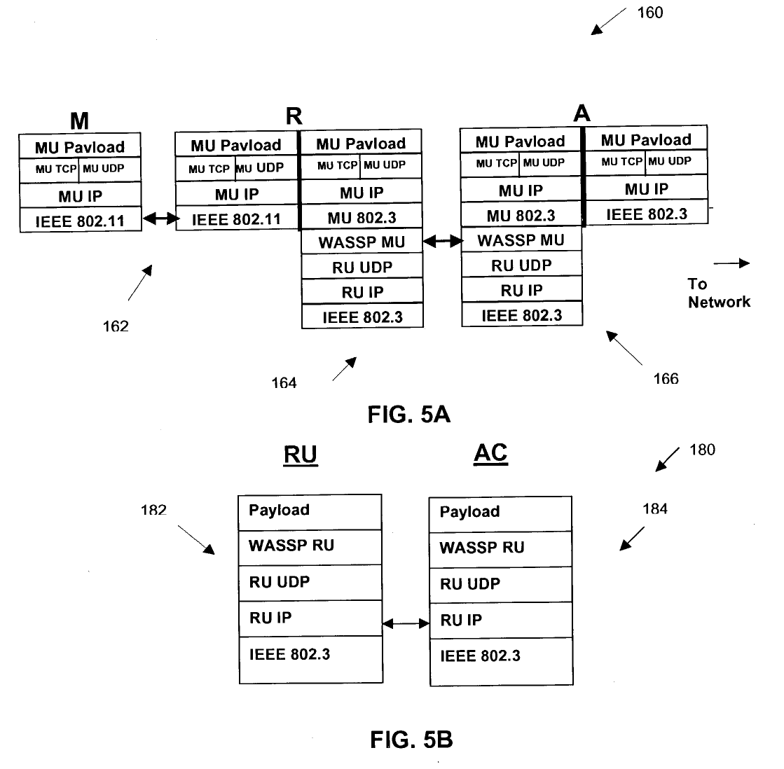

FIGS. 5A and 5B illustrate the protocol stacks associated with the mobile unit 30, radio unit 18 and the access controller 16 of wireless network 10. FIG. 5A illustrates the protocol stack that exists between mobile unit 30 and the end host that it wishes to communicate with. FIG. 5B is the protocol stack for communications between radio unit 18 and access controller 16. As is conventionally known, there are three main protocol layers, namely the Medium Access Control layer (MAC), the Network layer and the Transport layer. The MAC layer controls which device is allowed to transmit a message and helps to avoid “collisions” of data packet transmissions. The Network layer handles routing between nodes that are not directly connected. The Transport layer provides end-to-end application layer conversation between network nodes.

Now referring to FIG. 5A, the end-to-end communication protocol stack 160 between mobile unit 30 and an end host through radio unit 18 and access controller 16 is illustrated. The mobile unit protocol stack 162 associated with mobile unit 30 consists of four layers, namely a MU Payload layer, a MU TCP MU layer, a MU IP layer and an IEEE 802.11 layer. The MU TCP MU layer manages the assembling of messages into smaller packets for transmission over the wireless network to radio unit 18. The MU IP layer handles the address part of each data packet. It should be noted that MU Payload, MU TCP MU, and MU IP layers are not affected during the exchange of messages between radio unit 18 and access controller 16. That is, to mobile unit 30 and the end host, radio unit 18 and access controller 16 appear to be transparent at the MU IP MU level and above.

Radio unit protocol stack 164 contains eight protocol layers but only utilizes four protocol layers to communicate with access controller 16. Specifically, radio unit protocol stack 164 includes a MU payload layer, MU TCP MU layer, MU IP layer, MU 802.3 layer, WASSP MU layer, RU UDP layer, RU IP layer, and an IEEE 802.3 layer representing the radio unit's wired parameters. MU TCP MU layer that receives the packets from mobile device 30 via the RF interface 62 and reassembles them into the original message. Radio unit 18 provides conversion from IEEE 802.11 to IEEE 802.3 and provides WASSP encapsulation of packets being sent to access controller 16 having the MOBILE UNIT HEADER 151. Correspondingly, radio unit 18 provides conversion from IEEE 802.3 to IEEE 802.11 and WASSP de-encapsulation of packets being received from access controller 16. It should be understood that radio unit 18 never looks at the MU IP layer or those layers above (i.e. the top four layers are maintained intact through WASSP encapsulation).

Access controller protocol stack 166 associated with access controller 16 contains all eight layers of the radio unit protocol stack 164 and provides the MU Payload layer, MU TCP MU layer, MU IP layer, and the IEEE 802.3 layer to back-end network 50. Access controller 16 is responsible for removing the WASSP header from MOBILE UNIT HEADER 151 and converting the 802.3 headers from mobile unit 30 into new 802.3 headers. Access controller 16 only uses MOBILE UNIT HEADER 151 to determine which interface to send the packet out on.

FIG. 5B illustrates the protocol stack 180 associated with the communication between radio unit 18 and access controller 16 and the RADIO UNIT HEADER 150. The radio unit protocol stack 182 and the access controller protocol stack 184 both consist of five protocol layers, namely a Payload layer containing information associated with the Radio Unit Header TYPE, a WASSP RU layer, a RU UDP layer, a RU IP layer and an IEEE 802.3 layer.

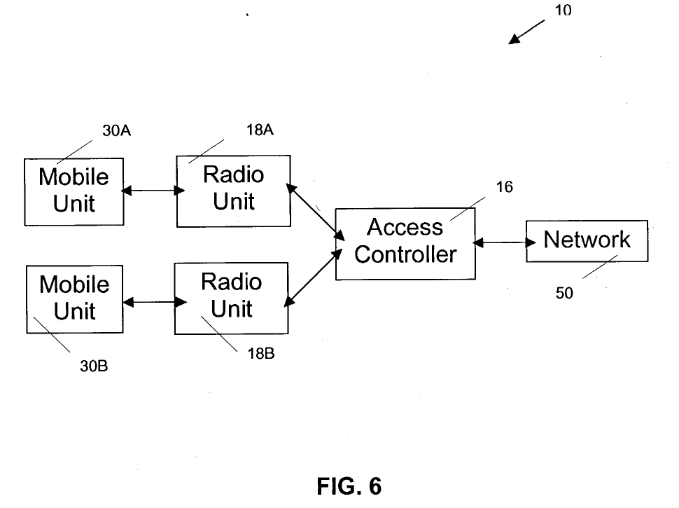

With reference to FIG. 6, the anti-spoofing mechanism of wireless LAN 10 will now be discussed. As shown, mobile units 30A and 30B connect to network 50 to establish a wireless connection to radio units 18A and 18B, respectively. Access controller 16 communicates with radio units 18A and 18B and controls operation of radio units 18A and 18B. Access controller 16 provides mobile unit session management including the termination of wireless sessions and mobility. Access controller 16 also provides network access, network services (e.g. IP filtering, Network Address Translating (NAT), Quality of Service (QoS), and routing), security and controls data transmission to the wired network as well as providing a management interface to the entire system (i.e. radio units 18A and 18B and access controller 16). Radio units 18A and 18B communicate with access controller 16 using the WASSP protocol. As detailed above, the WASSP protocol is used to exchange control messages and mobile unit 30A and 30B data between a radio unit 18A or 18B and an access controller 16.

Wireless LAN 10 determines whether both mobile unit 30A and mobile unit 30B are attempting to transmit or receive data with the same MAC or IP address. This is accomplished by first monitoring the state of mobile unit 30A at access controller 16. That is, the MAC address and IP address of mobile unit 30A as well as the radio unit it is connected to (e.g. radio unit 18A) are monitored. If another mobile unit e.g. mobile unit 30B connects to a different radio unit (e.g. radio unit 18B) with the same MAC or IP address, then access controller 16 will detect this and act accordingly as will be described.

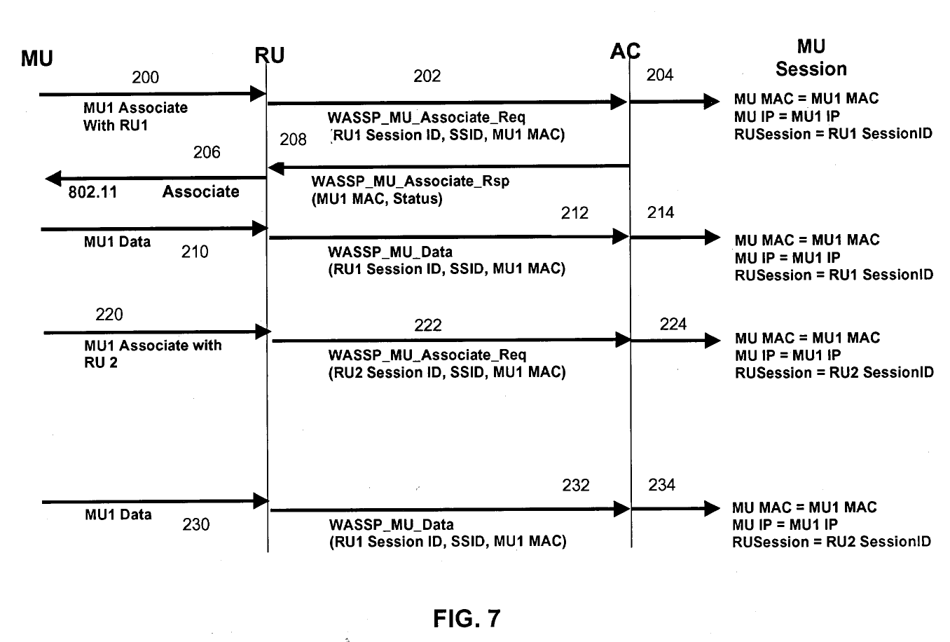

As shown in FIG. 7, access controller 16 keeps track of which radio unit 18A or 18B a particular mobile unit 30A or 30B is currently connected to by actively managing the 802.11 associate messages between mobile unit 30A (or 30B) and the associated radio unit 18A (or 18B). Specifically, as previously discussed, mobile unit 30A first registers with an 802.11 device, specifically a radio unit 18A in this example using an associate message. When mobile unit 30A sends out an associate message (200), the appropriate radio unit (e.g. 18A) sends a corresponding WASSP associate message (202) to access controller 16 to reflect this event.

Access controller 16 then registers mobile user 30A in a MU Session Table at (204) that is stored in a database within access controller 16 using the mobile user's 30A MAC address as the record identifier. The database entry for mobile user 30A is also marked to indicate that mobile user 30A is having a session on the specific radio unit 18A it is being associated with. If this is the first association of a session, mobile unit 30A will go through an authentication phase such as a Captive Portal or 802.1×message exchange at (206) and at (208). Then, once mobile unit 30A has been successfully authenticated, mobile unit 30A is free to transmit and receive data at (210), (212) and (214). Once mobile unit 30A is authenticated, it is free to roam to (i.e. associate with) other radio units (e.g. radio unit 18B).

Specifically, when mobile user 30A sends out an associate message (220) to second radio unit 18B sends a corresponding WASSP associate message (222) to access controller 16 to reflect this event. Access controller 16 then registers mobile user 30A in a MU Session Table at (224) that is stored in a database within access controller 16 using the mobile user's 30A MAC address as the record identifier. The database entry for mobile user 30A is also marked to indicate that mobile user 30A is having a session on the specific second radio unit 18B it is being associated with. Since this is not the first association of a session, mobile unit 30A will not go through another authentication and instead mobile unit 30A is free to transmit and receive data at (230), (232) and (234).

While mobile unit 30A is associated with radio unit 18A if another mobile unit 30B attempts to spoof the MAC of existing authenticated mobile unit 30A, and associate with a different radio unit 18, it will simply initially appear to access controller 16 as if mobile unit 30A has roamed to a new radio unit 18B. For the case where the authentication mechanism is not 802.1x, access controller 16 can only use the MAC address of mobile unit 30A to determine if it is already registered. Typically, this can lead to undetectable MAC address spoofing within wireless LAN 10.

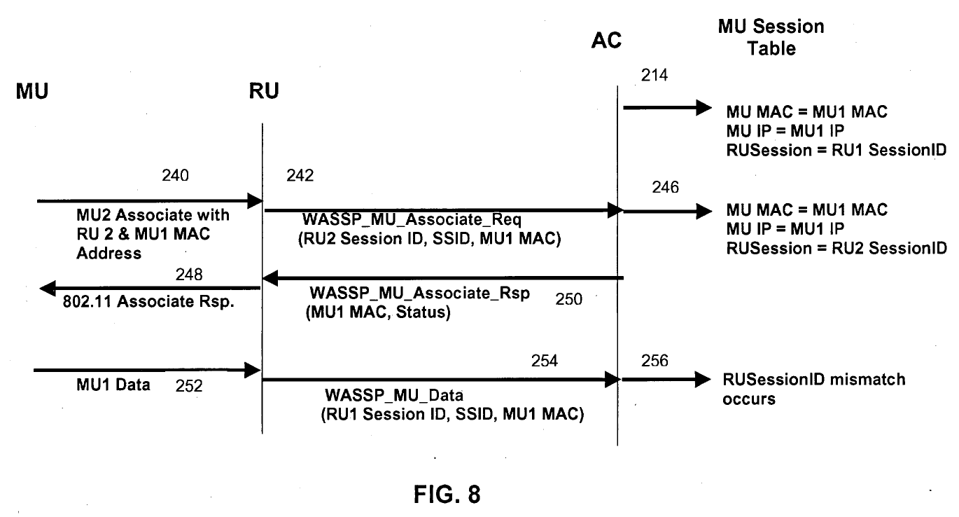

FIG. 8 illustrates the message exchange that occurs after access controller 16 has registered mobile user 30A in a MU Session Table using the mobile user's 30A MAC address as the record identifier and mobile user 30A has been authenticated at (214) (as discussed in reference to FIG. 7), when a second mobile unit 30B attempts to “spoof” the MAC address of mobile unit 30A and connects to second radio unit 18B (i.e. different from the radio unit that mobile unit 30A is in association with). Specifically, at (240), second mobile unit 30B “spoofs” the MAC address of mobile unit 30A and attempts to associate with second radio unit 18B. When second mobile unit 30B sends out an associate message (240), the second radio unit 18B sends a corresponding WASSP associate message (242) to access controller 16 to reflect this event. At this point, since second mobile unit 30B is attempting to “spoof” the MAC address of an existing authenticated mobile unit 30A, it will appear to access controller 16 as if mobile unit 30A has simply roamed to a new (i.e. second) radio unit 18B. Accordingly, access controller 16 will register in its MU Session Table that mobile unit 30A is now located at the new radio unit 18B. Since a second radio unit 18B is being connected to, an authentication phase may be conducted at (248) and (250).

However, when the originally authenticated mobile unit 30A transmits data as usual at (252) to its associated radio unit 18A the WASSP data message simply will be sent directly to access controller 16 at (254) without the need for an associate message (i.e. because mobile unit 30A is already presumed to be connected to radio unit 18A). The data from mobile unit 30A will now arrive at access controller 16, which routinely performs an integrity check on every data packet it receives. During this check access process at (256), controller 16 will discover that it has now received a data packet from mobile unit 30A. Even though mobile unit 30A is considered a valid mobile unit, the MU Session Table within the access controller 16 database will indicate that mobile unit 30A is in fact connected to a different radio unit 18B and a RUSessionID mismatch will occur. As a result, access controller 16 will determine that two devices are trying to connect to the wireless LAN 10 using the same MAC or IP Address.

Access controller 16 can respond to the detection of a RUSessionID mismatch in a variety of ways. First, access controller 16 can simply log that a RUSessionID mismatch event has occurred with the associated time/date and device particulars. Access controller 16 can also send a message to a network management station using an SNMP trap or access controller 16 can change the status of mobile unit(s) 30A and/or 30B to “unauthenticated”, disconnect the RF session, and require them to log back in. Finally, access controller 16 can add the MAC address of the mobile unit(s) 30A and/or 30B in question to a MAC address “black list” and prevent one or both mobile units from being able to re-connect to the wireless LAN 10.

As previously discussed in respect of FIGS. 4A, 4B, 4C, 5A and 5B, the WASSP protocol is used to exchange control messages and mobile unit 30A and 30B data between a radio unit 18A or 18B and an access controller 16. As discussed above, both RADIO UNIT HEADER 150 (FIG. 4A) and MOBILE UNIT HEADER 151 (FIG. 4B) allow for radio unit layer messages and mobile unit layer messages.

As previously noted, messages used by the radio unit layer are specified in the header field TYPE field of the RADIO UNIT HEADER 150, including a register request message, namely WASSP_RU_Register_Req that is used by radio unit 18 to register a request for a session with access controller 16. Access controller 16 uses a register response message, namely WASSP_RU_Register_Rsp to indicate to radio unit 18 that it has conditionally accepted the radio unit's 18 registration request based on knowing the serial number of radio unit 18 provided in the WASSP_RU_Register_Req message. The WASSP_RU_Register_Rsp message carries the challenge parameter to which radio unit 18 must properly respond in order to properly be considered successfully registered. Radio unit 18 also uses an authentication request message, namely WASSP_RU_Authenticate_Req when attempting to authenticate with the associated access controller 16 by providing a response to access controller's 16 challenge and providing a challenge to access controller 16 for mutual authentication. The authentication response message, namely WASSP_RU_Authenticate_Rsp is used by access controller 16 to acknowledge the authentication phase of the registration request from radio unit 18 and to respond to the challenge from radio unit 18.

The messages used by the mobile unit layer are specified in the header field TYPE of the MOBILE UNIT HEADER 151 which include these an associate request and an associate response. Specifically, the association request message, namely WASSP_MU_Associate_Req is used by radio unit 18 to relay a 802.11 association request received from mobile unit 30 to access controller 16. The association response message, namely WASSP_MU_Associate_Rsp is used by access controller 16 to authorize radio unit 18 to relay an 802.11 association response to mobile unit 30.

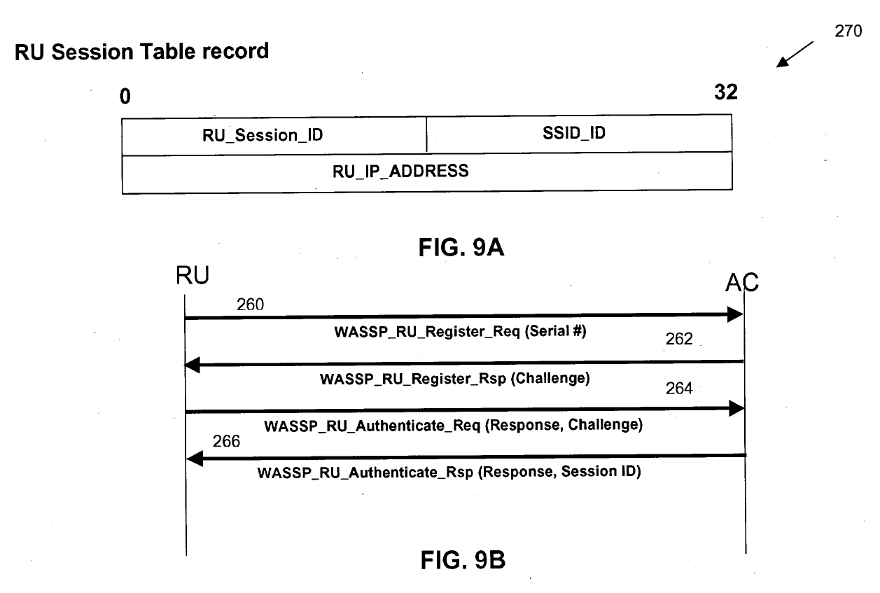

FIGS. 9A and 9B illustrate the structure of a RU Session Table records 270 maintained within the RU Session Table and their function. The RU Session Table record 270 consists of the necessary information required by the data plane associated with wireless LAN 10 to perform packet classification and encapsulation operations. The RU Session Table and its elements are defined and contained in SRAM within the access controllers 16 within wireless LAN 10.

FIG. 9A illustrates a RU Session Table record 270 that is populated in the shared memory of access controller(s) 16 associated with wireless LAN 10. Specifically, the RU Session Table record 270 consists of the following fields: RU_Session_ID, SSID_ID and RU_IP_Address. RU_Session_ID is a 16 bit, registration ID assigned by the session manager of access controller 16 as will be described. RU_Session_ID identifies the particular session between access controller 16 and radio unit 18. SSID_ID is a 16 bit, identifier representing the 802.11 Service Set Identifier (SSID) of radio unit 18. Finally, RU_IP_Address is a 32 bit, IP address of radio unit 18.

These records are populated automatically through the RU registration process during a WASSP_RU _Registration exchange. Specifically, once radio unit 18 is authenticated by access controller 16, access controller 16 assigns radio unit 18 a unique RU_Session_ID. This RU_Session_ID is stored in the RU Session Table along with other parameters. The RU_Session_ID is also provided in all WASSP packets that are exchanged between access controller 16 and radio unit 18. The primary purpose of the RU Session Table is to provide the processing components associated with the data plane with information to build WASSP encapsulation headers for mobile unit traffic. As data packets arrive that are destined for a particular mobile unit 30, access controller 16 will encapsulate these packets in a WASSP packet. This WASSP packet is delivered to the current radio unit 18 that mobile unit 30 is resident on. The IP address of the specific radio unit 18 is determined by searching the RU Session Table and leveraging a RU Session ID field.

As shown in FIG. 9B, the register request message, namely WASSP_RU_Register_Req is used by radio unit 18 at (260) to register a request for a session with access controller 16. The register response message, namely WASSP_RU_Register_Rsp is sent access controller 16 at (262) to indicate to radio unit 18 that it has conditionally accepted the radio unit's 18 registration request based on knowing the serial number of radio unit 18 provided in the WASSP_RU_Register_Req message. The WASSP_RU_Register_Rsp message carries the challenge parameter to which radio unit 18 must properly respond in order to properly be considered successfully registered. Radio unit 18 attempts to authenticate with access controller 16 by sending at (264) an authentication request message, namely WASSP_RU_Authenticate_Req in response to access controller's 16 challenge and providing a challenge to access controller 16 for mutual authentication. Access controller 16 then sends at (266) an authentication response message, namely WASSP_RU_Authenticate_Rsp to acknowledge the authentication phase of the registration request from radio unit 18 and to respond to the challenge from radio unit 18. Radio unit 18 is only considered to have successfully associated with access controller 16 if both registration and authentication phases complete successfully.

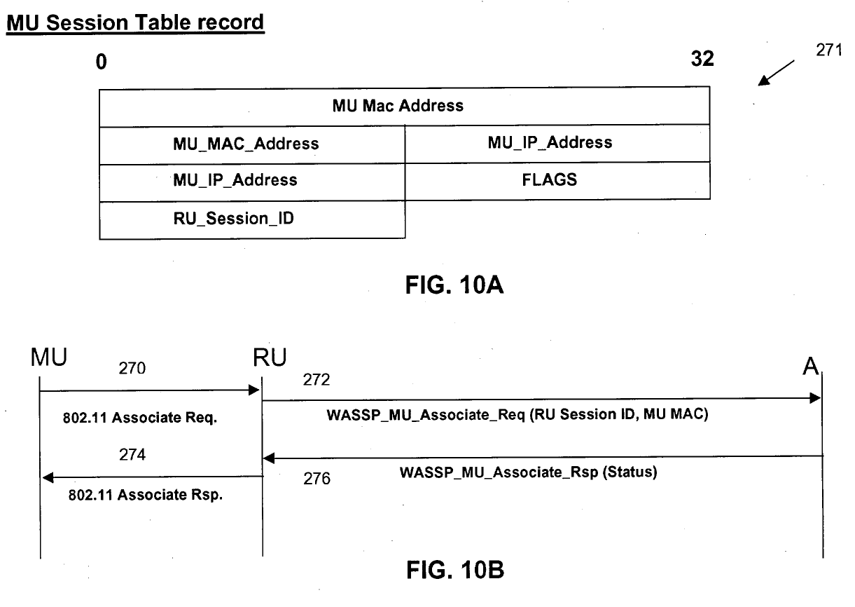

FIGS. 10A and 10B detail the MU Session Table records 271 maintained within the MU Session Table and their function. The MU Session Table records provide storage of information pertinent to the processing of packets within the data plane of wireless LAN 10. The handling of MU association requests by access controller 16 is key to the operation of managing the MU Session Table. The MU Session Table and its elements are defined and also contained in shared memory (i.e. SRAM) associated with access controller(s) 16 of wireless LAN 10.

FIG. 10A illustrates the MU Session Table record 271 that is populated in the shared memory of access controller(s) 16 associated with wireless LAN 10. Specifically, the record consists of the following fields: MU_MAC_Address, MU_IP_Address, FLAGS, RU_Session_ID. The MU_MAC_Address is the 48 bit MAC address of registered mobile unit 30. The MU_IP_Address field is a 32 bit field for holding the IP address of registered mobile unit 30 that is provided after mobile unit 30 sends a DHCP request. The FLAGS field is a 16 bit field that contains bit-field for flags that affect session state, such as indication of validation etc. For example, bit 0 of the FLAGS field is a Validation Flag. If bit 0 is set, it is indicates that the session has been properly validated and as such session traffic is allowed to occur. The other bits 1 to 14 are reserved for future functionality. The RU_Session_ID is a 16 bit field containing the RU_Session_ID field of radio unit 18 with access controller 16. As discussed above this field is automatically populated through the radio unit registration process i.e. when unit 18 registers with access controller 16.

As shown in FIG. 10B, when a mobile unit 30 attempts an 802.11 connection with wireless LAN 10, mobile unit 30 must first go through a negotiation with radio unit 18 that requires mobile unit 30 to send an 802.11 “Association Request” message as shown at (270). This associate operation is reported by radio unit 18 to access controller 16 at (272) using the WASSP_MU_Associate_Req message discussed above. This handling ensures that access controller 16 recognizes and then modifies or creates an appropriate MU Session Table record. When the WASSP_MU_Associate_Req message arrives at access controller 16, access controller 16 searches it's database to see if a session record already exists for mobile unit 30. This search is based on the MAC address of mobile unit 30 as provided in the WASSP_MU_Associate_Req message.

If this is the first time mobile unit 30 has attempted to connect to access controller 16 there will be no entry in the database for that mobile unit 30 and access controller 16 will create a new entry. Access controller 16 then at (274) responds to radio unit 18 with a WASSP_MU_Associate_Rsp message indicating that it has successfully updated the MU Session Table record for that mobile unit 30. In turn, radio unit 18 then provides an 802.11 “Association Response” at (276) to mobile unit 30. Otherwise, if an entry already exists for mobile unit 30 then the RU_Session_ID field in the MU Session Table is updated to reflect any changes to the MU Session record. For example when mobile unit 30 moves to a new radio unit 18, mobile unit 30 performs an association operation with that new radio unit 18. Access controller 16 is made aware of this request through the WASSP_MU_Associate_Req message and then updates the RU_Session_ID field of the MU Session Table record to reflect the identity of the new radio unit 18.

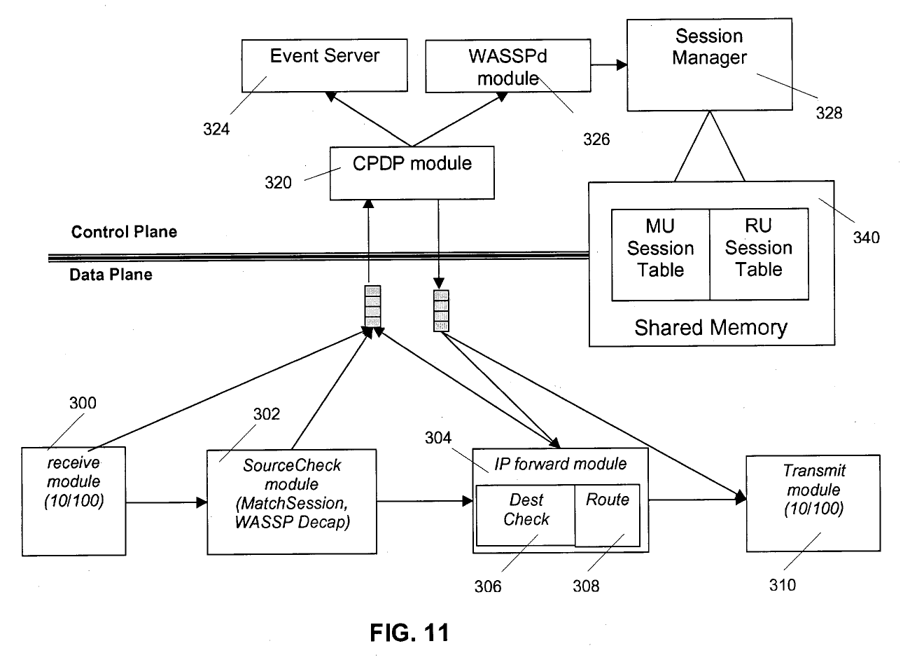

FIG. 11 illustrates how data packets are processed within the data plane and the control plane of wireless LAN 10. As shown, the data plane consists of a physical port 300, a source check module 302, an IP forward module 304, and a transmit module 310. The control plane consists of an CPDP module 320 which controls an event server 324 and a WASSPd (WASSP daemon) module 326 as well as a session manager 328 which controls the MU Session Table and the RU Session Table stored in shared memory 340.

Generally speaking, when access controller 16 receives a data packet, the data packet is first processed by source check module 302. Source check module 302 matches the WASSP MU data packet against its MU session record in the MU Session Table. The MU source MAC address is used to index into the MU Session Table to determine whether a session exists for mobile unit 30. From the retrieved MU session, the component can determine the policy that should be applied to the MU data packet. In particular, the MU Session Table record reveals the authentication status as well as the policies applicable to the packet. At this point the data packet is provided to IP forward module 304 where the destination of the data packet is validated and forwarded out the appropriate interface. If the data packet is destined for a mobile unit 30 that exists on a radio unit 18, the IP forward module 302 will encapsulate that data packet in WASSP and forward the WASSP data packet out the appropriate interface. If the data packet is intended for access controller 16 itself (e.g. a WASSP control packet), it is forwarded to the CPDP module 320 which then forwards on to the appropriate software component within access controller 16.

More specifically, packet processing begins when a data packet is received by a receive module 300 on access controller 16. Physical port 300 is responsible for receiving and re-assembly of packets received from the various enabled interfaces. Data packets are received from these physical interfaces into the received FIFOs (RFIFOs). The function of receive module 300 is to place the received data packets into memory and to perform the necessary header validation operations on a received data packet. Once receive module 300 has finished processing a data packet the data packet is next processed by either the Source Check module 302 within the data plane or by the CPDP module 320 within the control plane. Data packets sent directly to the CPDP module 320 are considered exception data packets, since they are packets that are not involved in the operation of WASSP, but are packets such as Ethernet Broadcasts, ARP, multicast, etc.

Source check module 302 is responsible for performing validations on WASSP packets such as determining the type of data packet (WASSP control or WASSP MU data packet), identifying the source of the data packet, etc. Source check module 302 first attempts to perform data packet classification in order to identify WASSP traffic. The primary use for such a classification is to determine whether or not the data packet represents a WASSP encapsulated MU data frame or not. If the packet is not a WASSP MU data packet it is forwarded on to the IP Forward module 304 for further processing. If the packet is a WASSP MU data packet, it is de-capsulated so that the original MU Packet is exposed for further processing. During the process of de-capsulation of MU data, a session matching function performs packet validation on the actual MU data packet and determines whether the mobile unit 30 at issue is associated with a valid session or not (i.e. to determine if there is an attempt to spoof an MU session).

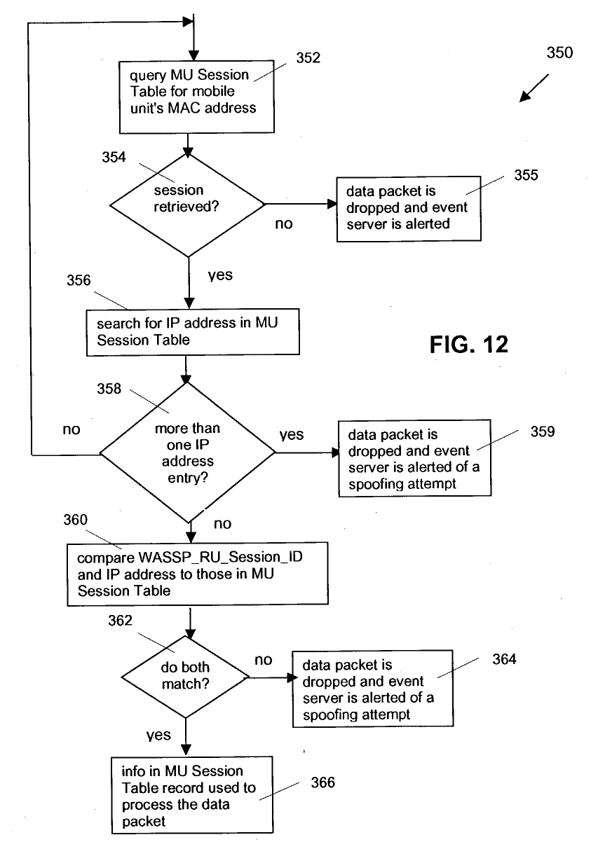

FIG. 12 illustrates the session matching process steps 350 that source check module 302 executes when determining whether a mobile unit 30 is requesting association with the wireless network 10 through radio unit 18.

At step (352), source check module 302 queries the MU Session Table within shared memory 340 for mobile unit's 30 MAC address. At step (354), it is determined whether a session is retrieved. If a mobile unit session is not found then at step (355) the data packet is dropped and the event server 324 is alerted that no current session exists in the MU Session Table for the mobile unit 30 at issue.

If a mobile unit session is retrieved, then mobile unit 30 has been registered as mobile unit 30 within MU Session Table and at step (356), a query is performed within the MU Session Table to determine if more than one entry exists for the source IP address of mobile unit 30 data packet. If so then at step (359), the data packet is dropped and the event server 324 is informed of a spoofing attempt. If not, then at step (360), the WASSP_RU_Session_ID is compared to the RU_Session_ID field and the IP address from the packet is compared to the IP address as retrieved from the MU Session Table. At step (362), it is determined whether both of these match. If either the WASSP_RU_Session_ID is different than the RU_Session_ID field (i.e. where the same MAC and IP address exists in association with another radio unit 18 in MU Session Table) or the IP addresses are different then at step (364), the data packet is dropped and the event server 324 is informed of a spoofing attempt.

Alternatively, if all of the matches are successful, then at step (366), the information in the retrieved MU Session Table record is utilized to further process the packet. After the above-noted process is successfully completed by source check module 302, the process of de-capsulation removes the WASSP header and then forwards the original mobile unit packet on to the IP Forward module 304.

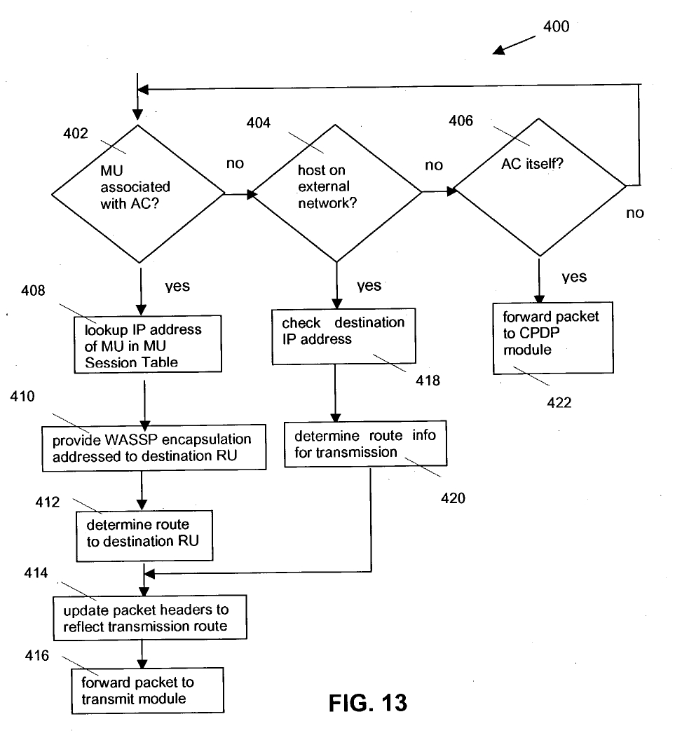

FIG. 13 illustrates the message processing steps 400 that the IP forward module 304 executes when forwarding a data packet based on the data packet's destination IP address. First, IP forward module 304 determines the appropriate route information for the transmission of the data packet based on the destination IP address. As shown in FIG. 13, at step (402), IP forward module 304 first determines whether the destination IP address indicates that the data packet is destined for a mobile unit 30 associated with access controller 16. If not, then IP forward module 304 at step (404) determines whether data packet is destined for a host on an external network. If not, then finally at step (406), IP forward module 304 determines whether data packet is destined for access controller 16 itself.

If at step (402), it is determined that the destination IP address represents an established mobile unit session (i.e. a mobile unit 30 associated with access controller 16), then IP forward module 304 conducts the following procedure. First, at step (408), IP forward module 304 queries the MU Session Table based on the IP Address of mobile unit 30. Next, at step (410), IP forward module 304 provides WASSP encapsulations with the WASSP data packet destined to the appropriate radio unit 18 based on what is determined from the MU Session Table. At step (412), IP forward module 304 determines the appropriate route information for the transmission of the data packet based on the RU IP address. Then at step (414), IP forward module 304 updates data packet headers (MAC headers) to reflect the transmission route. Finally, at step (416), IP forward module 304 forwards the data packet to transmit module 310 for further processing.

If at step (404) it is determined that data packet is destined for a host on an external network, then IP forward module 304 at step (418) checks the destination IP address. At step (420), IP forward module 304 determines the appropriate route information for transmission of the packet based on the destination IP address. Again, as in the case where the destination IP address represents an established mobile unit session, at step (414), IP forward module 304 updates data packet headers (MAC headers) to reflect the transmission route. Finally, at step (416), IP forward module 304 forwards the data packet to transmit module 310 for further processing.

If at step (406), it is determined that the data packet is destined for access controller 16 itself, then at step (422), IP forward module 304 forwards the data packet to the CDPD module 320 for further processing.

Transmit module 310 is responsible for processing the data packet for transmission and coordinating the sending of the data packet with the operations of the Transmit FIFO (TFIFO) scheduler. In essence, transmit module 310 is the component that simply sends the packet out the specific physical interface on access controller 16.

The CPDP (Control Plane Data Plane) module 320 is directly responsible for the exchange of packets between the data and control planes and represents the major interface mechanism between these two planes. The role of CPDP module 320 is to facilitate the flow of packet data between applications in the control plane and the data plane. Packets received from the data plane that are targeted for the control plane are treated by CPDP module 320 and forwarded to the host processor's stack where they will be handled by the appropriate application. An example of such a traffic flow, is where radio unit 18 attempts to send a WASSP control message to access controller 16. In such a case, the data packet is received at the data plane, handed to the CPDP module 320 which is then in turn responsible for delivering the data packet to the host processor's control plane for processing by the WASSPd module 326. Additionally, CPDP module 320 is also responsible for delivering data packets originating from the control plane to the transmission functional set of the data plane where the data packet will be sent out the necessary port (i.e. in route to the appropriate destination). Additionally, CPDP module 320 is also involved in the “interception” of exception traffic (traffic between data and control planes) for the purpose of identifying packets containing relevant information to the system operation (such as MU DHCP transactions), or even to determine whether the data packet is destined for a registered mobile unit 30 at which point it requires the correct set of encapsulation WASSP_MU_DATA headers before transmission.

The WASSPd (WASSP daemon) module 326 is responsible for the encoding/decoding of WASSP control packets that are exchanged between access controller 16 and radio units 18. When control packets are received from a radio unit 30, WASSPd module 326 interprets these packets and forwards their contents onto the Session Manager 328. Additionally, in response to control messages the Session Manager 328, information will be forwarded to WASSPd module 326 for encoded into a WASSP packet and then to be forwarded onto the appropriate radio unit 18 through the CPDP module 320.

Session manager 328 is responsible for the management of the RU Session Table and MU Session Table which are stored in shared memory 340. Session manager 328 is composed of an RU manager (not shown) and a MU manager (not shown). The RU manager is responsible for the management of entries in the RU Session Table. Updates to the RU Session Table are performed by this module based on the WASSP RU control messages received by the WASSPd module 326. The MU manager is responsible for management of entries in the MU Session Table. Updates to the MU Session Table are performed based on the WASSP MU control messages received by the WASSPd module 326. It should be understood that shared memory 340 can be accessed by various access servers 16 within wireless network 10. In this way, anti-spoofing procedures can be coordinated amongst a plurality of access servers 16 to provide anti-spoofing functionality throughout wireless LAN 10.

Event server 324 is responsible for the logging, recording and management of events that are sent from the various access controller components (modules). Events that arrive at event server 324 can be logged for later retrieval, real-time viewing and can trigger another event such as an SNMP trap. The purpose of the event log is to provide a managed infrastructure onto which system components may record activity occurrences of particular interest to the state of the system (or subsystems). These occurrences are reported to the event server 324 via messaging (known as an even) which contains the particulars of the activity being logged as well as indication of the severity of the indicated occurrence, such as Major, Minor and Information. The severity of the reported event has to do primarily with the nature of the occurrence, where Major represents the highest level of alert and may indicate activity like component failure or intrusion detection. Minor and Information indicate primarily activity that is not so severe and in many cases indicates normal state changes of the system. As an example of logged activity, Event Server 324 is notified as an Info when a mobile unit 30 associates with wireless LAN 10, or when a radio unit 18 registers with the wireless LAN 10.

Accordingly, referring back to FIG. 6, the present invention prevents network address spoofing within a wireless network by adapting access controller 16 to monitor the association of first mobile unit 30A (FIG. To first radio unit 18A. When this association occurs, access controller 16 determines the network address of first mobile unit 30A and maintains a connectivity record that contains the network address of first mobile unit 30A and identifies the association of first radio unit 30A with first radio unit 18A. If second mobile unit 30B requests association with second radio unit 18B then the network address of second mobile unit 18B is determined. If the network address of second mobile unit 18B is the same as the network address of the first mobile unit 30A then the connectivity record associated with the network address of said first and second mobile units 30A and 30B is checked. If the connectivity record indicates an association with first radio unit 18A then an anti-spoofing protocol.

This anti-spoofing protocol can include, but is not limited to, the following. First, access controller 16 can simply log that a RUSessionID mismatch event has occurred with the associated time/date and device particulars. Access controller 16 can also send a message to a network management station using an SNMP trap or access controller 16 can change the status of mobile unit(s) 30A and/or 30B to “unauthenticated” and require them to log back in. Finally, access controller 16 can add the MAC address of the mobile unit(s) 30A and/or 30B in question to a MAC address “black list” and prevent one or both mobile units from being able to re-connect to the wireless LAN 10.

As will be apparent to those skilled in the art, various modifications and adaptations of the structure described above are possible without departing from the present invention, the scope of which is defined in the appended claims.

1. A method for preventing network address spoofing in respect of a plurality of mobile units within a wireless network, said wireless network including an access controller and first and second radio units, said method comprising:
(a) associating a first mobile unit to the first radio unit, determining the network address of said first mobile unit and maintaining a connectivity record that contains said network address and that indicates an association with said first radio unit;
(b) receiving an associate request from a second mobile unit to associate with the second radio unit and determining the network address of said second mobile unit;
(c) determining if the network address of the second mobile unit is the same as the network address of the first mobile unit;
(d) if the determination in (c) is true then retrieving the connectivity record associated with the network address of said first and mobile units and determining whether said connectivity record indicates an association with the first radio unit; and
(e) if the determination in (d) is true then executing an anti-spoofing protocol.

2. The method of claim 1, wherein the anti-spoofing protocol includes the step of generating a spoofing log indicating that a spoofing incident has occurred.

3. The method of claim 1, wherein the anti-spoofing protocol includes the step of sending a SNMP trap of the event to a network management station indicating that a spoofing incident has occurred.

4. The method of claim 1, wherein the anti-spoofing protocol includes the step of un-authenticating said first and second mobile units such that said first mobile unit is disconnected from the wireless network and such that said second mobile unit is prevented from connecting to the wireless network.

5. The method of claim 1, wherein the anti-spoofing protocol includes the step of preventing said second mobile unit from connecting to the network.

6. The method of claim 1, wherein the anti-spoofing protocol includes the steps of un-authenticating said first mobile unit such that said first mobile unit is disconnected from said wireless network and preventing any mobile unit with the network address of said first and second mobile units from connecting to the wireless network.

7. The method of claim 1, wherein the network address is the MAC address.

8. The method of claim 1, herein the network address is the IP address.

9. The method of claim 1, wherein the connectivity record for said first mobile unit is periodically updated to reflect the association status of said first mobile unit with said first and second radio units.

10. The method of claim 1, wherein the connectivity record is indexed by MAC address.

11. A wireless network for preventing network address spoofing of a first mobile unit by a second mobile unit, said network comprising:
(a) first and second radio units;
(b) an access controller coupled to said first and second radio units and being adapted to:
(i) associate the first mobile unit to the first radio unit, determine the network address of said first mobile unit and maintain a connectivity record that contains said network address and that indicates an association with said first radio unit;
(ii) receive an associate request from a second mobile unit to associate with the second radio unit and determine the network address of said second mobile unit;
(iii) determine if the network address of the second mobile unit is the same as the network address of the first mobile unit;
(iv) retrieve the connectivity record associated with the network address of said first and mobile units if the determination in (iii) is true and determine whether said connectivity record indicates an association with the first radio unit; and
(v) execute an anti-spoofing protocol if the determination if (iv) is true.

12. The network of claim 11, wherein the access controller is adapted to execute the anti-spoofing protocol by generating a spoofing log indicating that a spoofing incident has occurred.

13. The network of claim 11, wherein said network includes a network management station coupled to said access controller, wherein the access controller is adapted to execute the anti-spoofing protocol by sending a SNMP trap of the event to the network management station that indicates that a spoofing incident has occurred.

14. The network of claim 11, wherein the access controller is adapted to execute the anti-spoofing protocol by un-authenticating said first and second mobile units such that said first mobile unit is disconnected from the wireless network and such that said second mobile unit is prevented from connecting to the wireless network.

15. The network of claim 11, wherein the access controller is adapted to execute the anti-spoofing protocol by preventing said second mobile unit from connecting to the network.

16. The network of claim 11, wherein the access controller is adapted to execute the anti-spoofing protocol by un-authenticating said first mobile unit such that said first mobile unit is disconnected from said wireless network and preventing any mobile unit with the network address of said first and second mobile units from connecting to the wireless network.

17. The network of claim 11, wherein the network address is the MAC address.

18. The network of claim 11, wherein the network address is the IP address.

19. The network of claim 11, wherein the access controller periodically updates the connectivity record for said first mobile unit to reflect the association status of said first mobile unit with said first and second radio units by monitoring instances of association and disassociation messages.

20. The network of claim 11, wherein the connectivity record is indexed by MAC address.
